(19) United States
(12) Patent Application Publication
(10) Pub. No.: US 2026/0356039 A1
(43) Pub. Date: Nov. 12, 2026

(54) ADDITIVE MANUFACTURING USING MULTIPLE LASER BEAMS

(71) Applicant: SOLROM HOLDINGS LTD., Rosh Haayin (IL)

(72) Inventor: Daniel MAJER, Givat Shmuel (IL)

(73) Assignee: SOLROM HOLDINGS LTD., Rosh Haayin (IL)

(21) Appl. No.: 19/113,710

(22) PCT Filed: Dec. 27, 2023
(86) PCT No.: PCT/IL2023/051316

§ 371 Date: Mar. 20, 2025

Related U.S. Application Data
(60) Provisional application No. 63/477,305, filed on Dec. 27, 2022.

(51) Int. Cl. B29C 64/282; B29C 64/153; B29C 64/268; B29C 64/393; B33Y 10/00; B33Y 30/00; B33Y 50/02

(52) U.S. Cl. CPC B29C 64/282; B29C 64/153; B29C 64/268; B29C 64/393; B33Y 10/00; B33Y 30/00; B33Y 50/02

(57) ABSTRACT

The invention includes a process and a system for simultaneously laser sintering a powder bed at multiple depths thereof.

### TECHNOLOGICAL FIELD

The invention generally contemplates a process and a system for selective laser sintering employing a multiwavelength laser source.

### BACKGROUND OF THE INVENTION

3D printing is an Additive Manufacturing (AM) or Rapid Prototyping (RP) process tailored for making a three-dimensional solid object from a digital model, by forming successive layers of material one on top of the other.

Selective laser sintering (SLS) utilizes a high-power laser to sinter small particles of a polymer powder into a solid structure based on a 3D model. Sintering primarily occurs when the powder particles are melted forming a micro-melt layer at the region exposed to the laser, being typically the surface layer of the polymer powder, resulting in a reduction in viscosity and formation of a concave radial bridge between particles.

SLS begins with a thin layer of powder spread evenly onto a flat surface with a roller mechanism. The powder is then scanned with a high-power laser beam, which melts the powder and fuses it while powder regions not irradiated by the laser remain dissociated. Successive layers of powder are deposited and scanned, one on top of another, until the object is formed. Each layer is sintered deeply enough to bond it to the preceding layer. The depth of sintering poses a significant constraint that limits adhesion between printed layers, resulting in reduced mechanical strengths.

### BACKGROUND PUBLICATIONS

[1] U.S. Pat. No. 10,029,421

### GENERAL DESCRIPTION

The inventors of the technology disclosed herein have developed a process and a system for laser sintering in which an object is produced layer-by-layer by irradiating a powder bed formed of a material composition of the object. Laser irradiation used for melting or coalescing or sintering the powder may be (i) a single beam of two or more combined lasers having different wavelengths or (ii) two or more independent laser beams generated from different laser sources, such that each of the two or more independent laser sources is selected for generating a laser beam of a different characteristic, e.g., different wavelength, absorption depth, laser profile, polarizability and/or energy; the use of either laser configuration enables sintering or melting or coalescing of different materials of the material composition or sintering or melting of the material composition at two different depths of the powder bed. In other words, processes and systems of the invention are configured and operable to simultaneously or sequentially utilize a laser source for generating an irradiation of two or more wavelengths, such that each wavelength is selective to sinter or melt the material composition at different depths of the powder bed and/or selective to sinter or melt a different component of the material composition present in the powder bed. As will be further demonstrated hereinbelow, by using a laser beam having two or more distinct wavelengths, more effective sintering and adhesion between the material layers and a better print quality can be achieved.

The ability of powder particles to absorb energy radiation is known to be a dominant premise for the powder bed process. Modifying absorption of the laser radiation enabled modulation of the penetration depth, which led to a significant material melting, as well as to selective melting of particular components of the powder particles. As a result, the size of the molten pool could be increased or controlled, promoting enhanced sintering and formation of good layer bonding ability.

Thus, the invention generally contemplates a process and a system for manufacturing an object or a pattern by simultaneous or sequential laser-beam irradiation of a powder bed by employing a laser source(s) that is configured and operable for generating a plurality of laser beams of different characteristics, e.g., different wavelengths, such that each of the plurality of laser beams enables sintering or melting of a different material of the powder bed or of a material provided at a different depth of the powder bed.

In a first aspect of the invention, there is provided a process for forming an object or a workpiece, the process comprising irradiating a powder bed formed of a material composition of the object by laser source generating a single beam laser of two or more wavelengths or by two or more independent laser sources, each laser source generating a laser beam of a different characteristic, e.g., different wavelengths, to thereby cause sintering or melting of different materials of the material composition or sintering or melting at two different depths of the powder bed. Also provided is a process for forming an object or a workpiece, the process comprising irradiating a powder bed formed of a material composition of the object by laser source being a single beam laser of two or more wavelengths or by two or more independent laser sources, each laser source generating a laser beam of a different characteristic, to thereby cause sintering or melting of same or different materials at two different depths of the powder bed.

Further provided is a process for forming an object or a workpiece, the process comprising irradiating a powder bed formed of a material composition of the object (i) by a single laser beam generated by a laser source, wherein said single laser beam being of two or more wavelengths, or (ii) by two or more laser beams combined into a single beam, each of the two or more laser beams having a different wavelength and each generated by a different laser source, wherein the irradiation of the powder bed causes sintering or melting of the material composition at two different depths of the powder bed.

Generally, 3D objects of a variety of shapes, sizes and uses may be formed or fabricated utilizing processes and systems of the invention. The fabrication processes may involve Additive Manufacturing (AM) or Rapid Prototyping (RP) processes whereby successive layers of a material are formed one on top of the other. In generating the layers, Selective laser sintering (SLS) utilizing a high-power laser melt or partially melt particles of the material, e.g., a polymer powder, causing the particles to sinter or coalesce. Successive layers of powder are deposited and scanned, one on top of another, until the object is formed. Each layer is sintered deeply enough to bond it to the preceding layer.

In some embodiments, the irradiating of the powder bed comprises directing a single beam laser of two or more wavelengths in a direction of a region of the powder bed to thereby cause sintering of two different materials contained in the powder material, and/or to cause sintering of the layer material at two different depths of the material layer.

Alternatively, the irradiating may comprise directing two or more laser beams, each generated from an independent laser source and each being of a different wavelength in a direction of a region of the powder bed, to thereby cause sintering or melting of two different materials of the material composition or sintering or melting at two different depths of the powder bed.

The invention also provides a process for forming a 3D object, the process comprising layer-by-layer sintering of a material composition of the object, wherein a powder layer having a predetermined material composition and thickness is irradiated by a single beam laser of two or more wavelengths or by two or more different simultaneously generated laser beams, each having a different characteristic and each generated by an independent laser source, causing sintering or melting of a different material of the material composition or sintering or melting the material composition at two different depths of the layer.

In some embodiments of the layer-by-layer process, a first of said two or more wavelengths is selective to cause sintering or melting of at least one material of the material composition, and a second of said two or more wavelengths is selective to cause sintering of at least one another material of the material composition, wherein a laser of the first wavelength and a laser of the second wavelength are irradiated simultaneously or sequentially and wherein the first and second wavelengths are different.

In some embodiments of the layer-by-layer process, a first of said two or more wavelengths is selective to cause sintering or melting of the material composition at a first depth of the powder layer, and a second of the two or more wavelengths selective to cause sintering of the material composition at a second depth of the powder layer, wherein a laser of the first wavelength and a laser of the second wavelength are generated simultaneously or sequentially and wherein the first and second depths of the powder layer are separated by a predetermined distance (e.g., a distance of at least 10 microns, and at times between 10 and 100 microns).

The laser source used in processes and systems of the invention may be a single beam laser source comprising coaxially aligned plurality of laser beams (two or more), each having a different wavelength and configured to direct a combined beam toward a substantially single common point or region on the powder layer and cause sintering or melting of the powder at that point. As noted herein, the utilization of two or more different laser sources is also possible, wherein each of the different laser sources generates a laser beam of a different wavelength and a different energy allowing for achieving different adsorption depths and/or sintering of different materials at the point of irradiation.

Multi-wavelength combiners may be used to efficiently combine multiple wavelength laser beams into one common output. The spectral beam combining may involve utilization diffraction grating, or dichroic mirror.

In some cases, a beam combining element is in a form of a dichroic mirror. The dichroic mirror may be used to combine beams of different wavelengths and transmit one wavelength (or a plurality or a range of wavelengths) whilst reflecting others with high efficiency. The dichroic mirror may be provided with a thin-film coating to provide well-defined transition edges (i.e., a spectral range between what wavelength that is transmitted and that which is reflected) such that beams of similar wavelengths can be effectively combined.

Where the laser beams are polarized, an efficient combination may be achieved using a polarizing beam splitter (PBS). Reflective polarizers reflect s-polarized light whilst transmitting the p-polarizations. This is depicted for example in FIG. 1.

Beam combining may also be achieved with refractive and diffractive elements. In some cases, a prism may be used. In such a case, the dispersion (ability to separate wavelengths) is such that there needs to be a substantial separation between the wavelengths being combined, to prevent use of a large space that may be required to effectively separate the wavelengths. As known in the art, unlike prisms, diffraction gratings offer more flexibility in design. The gratings dispersion is dependent on e.g., their groove spacing, rather than the fundamental optical constants of the substrate material. As such, diffraction gratings provide a proper means for combining closely separated wavelengths.

The “laser source” used for generating the laser beams is an energy or light source that is configured to emit radiation coherently. The laser source may comprise a single gain medium, such as a single semiconductor component that is operable for emitting coherent radiation, typically at a single central or mean wavelength. An emission spectrum of the laser source may be characterized by an emission range within less than 30% of the mean emission wavelength, less than 15%, less than 10% of the mean emission wavelength, or less than 5% of the mean emission wavelength.

Additionally, the laser source may be configured for emitting two separate wavelengths in the same semiconductor device.

The laser source may be a tunable laser source having at least one property which can be controlled and/or adjusted. For example, the tunable laser source may comprise one or more of a semiconductor tunable laser, a Sample Grating Distributed Bragg Reflector laser (SG-DBR), an external cavity laser, a diode laser, a vertical cavity surface-emitting laser (VCSEL), a vertical cavity surface-emitting laser array, a distributed feedback laser, a Photonic Crystal Surface-emitting Laser (PCSEL) and others. The tunable laser source may be tunable over a wavelength range from 3,700 to 4,500 nm, or from 4,000 to 5,000 nm or from 5,000 to 6,000 nm or any other wavelength range in the 3,700 nm to 15,000 nm range. The at least one property of the tunable laser source may be a voltage, a current, a temperature, an emission wavelength, an intensity and others. For example, the emission wavelength of the tunable laser source may be adjustable by one or more of varying a driver current, changing a MEMS state, changing a modulation of an electro-optical or an acousto-optical modulator etc. The emission wavelength of a coherent light emitted by the tunable laser source may depend on the driver current by which the tunable laser source is driven and/or the temperature.

In some embodiments, the plurality (two or more) of laser sources generates laser beams of different wavelengths or same wavelengths but with opposite polarizations. As shown in FIG. 2, lasers of the same wavelengths but of opposite polarizations (labeled wavelength #1, P-pol and wavelength #1, S-pol) may be combined using a polarization beam splitter (PBS) into single beam of wavelength #1. A second laser set comprising two laser sources, each generating a laser beam of a wavelength #2 being different from wavelength #1, generate laser beams of same wavelengths #2 but with opposite polarizations (labeled wavelength #2, P-pol and wavelength #2, S-pol) are combined using a second PBS into a single beam of wavelength #2. The two laser beams may be combined using a dichroic mirror into a single beam having two (or a plurality) of wavelengths, as disclosed herein.

The laser generated and used in processes and systems of the invention may be a laser of any of the different types of lasers known in the art. The laser may be selected based on their gain medium. In some embodiments, the laser is selected from gas lasers, solid-state lasers, fiber lasers, liquid lasers (dye lasers) and semiconductor lasers (laser diodes).

In some embodiments, the laser is a quantum cascade laser (QCL), a CO₂ laser, a fiber laser, a diode laser or any other laser typically used with powder bed printing systems. In some embodiments, the laser is at least one QCL laser or an array of at least two QCL, at least two CO₂ lasers, at least two fiber lasers, at least two diode lasers or a combination of two or more laser types.

In some configurations, the laser is a QCL laser.

The selection of the different wavelengths may require selection of different laser sources, which may comprise selection of different laser sources amongst gas lasers, solid-state lasers, fiber lasers, liquid lasers and semiconductor lasers. The different lasers, each having a different wavelength, may be selected amongst any of gas lasers, solid-state lasers, fiber lasers, liquid lasers and semiconductor lasers, or may be selected from gas lasers, or solid-state lasers, or fiber lasers, or liquid lasers or semiconductor lasers. Different lasers may be selected based, inter alia, on power produced by the laser to ensure that most of the laser energy is absorbed by the powder in the powder bed or powder layer, instead of being bounced off the powder surface. For example, when using a polyamide powder, a CO₂ laser may be preferrable as a large part of the power produced by the laser is absorbed by polyamide powder, instead of being bounced off the powder surface.

The different lasers may be selected based on their wavelength, independently of the laser gain medium. As used herein, the term “different wavelength” encompasses two or more laser wavelengths that are distinct from each other, wherein the wavelength difference (e.g., when using a dichroic mirror in the IR) is at least 0.1 micrometers (μm). In some cases, the difference in wavelengths may be at least 0.5, 0.6, 0.7, 0.8, 0.9, 1 μm, and even greater. While the selection of a proper pair of wavelengths may depend, inter alia, on the material composition, the size of particles used, the shape of the particles, the distribution of sizes and shapes, the layer depths to be irradiated, etc, both empirical and simulated data can be used for determining a proper pair of wavelengths and a sufficient wavelength difference may be generated, as further disclosed herein. Non-limiting examples of wavelength pairs that may be used as a first wavelength and a second wavelength, e.g., of a single beam coaxially combining two or more laser beams are listed in Table 1 below:

TABLE 1

| Wavelength A (μm) | Wavelength B (μm) |
|---|---|
| 3.8 | 4.35 |
| 4 | 7 |
| 4.5 | 10.6 |
| 5 | 5.4 |
| 5.3 | 8 |
| 5.7 | 4.9 |
| 6 | 7.7 |
| 6.5 | 4.2 |
| 7.5 | 6.6 |
| 7.9 | 6.9 |
| 10.6 | 5.3 |
| 6.8 | 3.8 |
| 4.2 | 4 |
| 5.5 | 4.5 |
| 6.2 | 5 |
| 7.5 | 5.3 |
| 6 | 5.7 |
| 10.6 | 6 |
| 7.9 | 6.5 |
| 6.2 | 7.5 |
| 10.6 | 7.9 |
| 6.8 | 10.6 |

Thus, for example, in a process of the invention for forming an object or a workpiece, the process comprising irradiating a powder bed formed of a material composition of the object by a single beam laser of two or more wavelengths, e.g., wavelength A and wavelength B of the above table, to thereby cause sintering or melting of different materials of the material composition or sintering or melting at two different depths of the powder bed.

The wavelength used may depend on the powder composition to be used in forming the object. Typically, the powder used is one necessary for achieving a printed object with predetermined or desired mechanical properties. When the powder composition is selected, the wavelength suitable for causing energy absorbance by the powder particles and subsequent melting and coalescence is selected. Alternatively, the powder composition may be selected based on the operating laser system and particular wavelengths employed. Irrespective of the protocol used, the powder employed in processes of the invention for forming a variety of objects or workpieces is typically a powder of one or more organic or inorganic materials. The powder may be selected amongst such typically used in processes involving selective laser sintering (SLS). In some cases, the powder may be any one or more of the thermoplastic materials, e.g., polyamide polymers, polypropylene, polybutylene terephthalate (PBT), poly ether ether ketone (PEEK), poly ether ketone ketone (PEKK), thermoplastic amide (TPA), thermoplastic copolyester (TPC), thermoplastic polyurethane (TPU) and others.

The powder may be provided as a mixture of such thermoplastic materials and may contain also functional additives such as reinforcing materials, e.g., carbon fibers, glass beads; fire retardant materials; colorants, e.g. dyes; and others.

Non-limiting examples of powders suitable for manufacturing objects according to the invention include without limitation Nylon 6, Nylon 11, Nylon 12, polyamide with carbon fibers, polyamide with electrostatic discharging capabilities, polyamide with a flame retardant, polyamide with glass fibers or glass beads, PBT, PEEK, PEKK, polypropylene, TPA, TPC, TPU and others.

The powder composition may comprise a single material or a plurality or two or more materials, which in combination make the powder layer or powder bed. In some embodiments, in a process of the invention, the process comprising irradiating a powder bed formed of a material composition of the object by laser source being a single beam laser of two or more wavelengths or by two or more independent laser sources, each laser source generating a laser beam of a different characteristic, e.g., different wavelengths, to thereby cause sintering or melting of the material composition at two different depths of the powder bed, wherein the material composition comprises a single material having a narrow distribution of sizes and shapes. The distribution of sizes or shapes is narrow when the particles sizes or shapes are of a similar size or shape. The “narrow particle distribution” is used to describe such a uniformity.

Generally, the powder particles may be spherical as the use of such particles maximizes the powder bed density and flowability. However, where high porosity objects are desired, particles having morphological irregularities may be used.

The particles' dimensions and size distribution may also vary. However, to maximize powder bed density (and maximize object density where porous objects are not desired), suitable size and size distribution are required, in addition to a spherical shape. Also, to achieve a powder layer with a thickness ensuring that powder melting occurs due to direct interaction between the laser beam and the particles, rather than due to in-layer heat conduction between particles, and further that sintering may be effectively achieved in different depths of the powder layer, the layer thickness should be selected in consideration of the average size of the particles.

The inventors have now demonstrated that powder layers having thicknesses of between about 10 and 300 μm or between 10 and 150 μm allow achieving both surface sintering as well as sintering at various layer depths.

In some embodiments, each layer formed and sintered as disclosed may be between 100 and 300 μm, or between 10 and 150 μm, wherein the diameter of the powder particles (assuming spherical or substantially spherical) may be selected to between about 10 and 90 μm or between 45 and 90 μm or between 75 and 100 μm or between 20 and 50 m or between 50 and 100 μm. The size distribution of particles is typically narrow.

To cause and achieve “ . . . sintering or melting of the material composition at two different depths of the powder bed . . . ”, based on a selected powder composition, particle size, layer thickness and particles shape, the absorption depths which are optimal to melt the material are first determined. The calculation includes one or more of optical absorption, optical refraction, optical transmission, thermal conductivity, surrounding temperature and melting temperature. At least two absorption depths are selected; one which absorbs at the surface of the material and another which is absorbed more deeply in the material. An FTIR measurement of the material is obtained to determine the material spectral transmission. Thereafter, based on the transmission, the wavelengths that have the absorption depths previously chosen may be determined. Optimization of the two or more wavelengths results in a fast and efficient melting of the particles to create a mechanically strong and accurate part with excellent surface details.

When viewed from the point of view of layer depths or layer thickness, for a powder layer having a thickness ranging from 10 to 300 μm, the powder properties are used to measure or determine the optimal absorption depths for melting the powder at the given layer thickness. At least two absorption depths are selected to optimally melt the layer top surface, for example from the surface to a depth of few microns, e.g., 10 μm (namely from depth zero to 10 μm below surface), while also melting a middle and in-depth portion of that layer, for example from the surface to a depth of 100 μm (namely from depth zero to 100 μm below surface). Once these depths are determined, the correct wavelengths that match these absorption depths are obtained or determined from the FTIR scan of the relevant powder. Using at least two absorption lengths improves the mechanical properties of the printed part such that we get isotropic Stress-Strain curves.

Thus, in some configurations of the process, the different wavelengths suitable for sintering the powder bed at two different depths are determined by (i) determining powder material composition, powder particle size and shape and layer, (ii) determining on one or more of composition optical absorption, optical refraction, optical transmission, thermal conductivity, surrounding temperature and composition melting temperature, (iii) selecting at least two absorption depths; (iv) determining a spectral transmission of the composition, and, (v) determining the two different wavelengths that exhibit the optimal absorption depths. The two wavelengths used may be selected to melt and coalesce powder depths as non-limitedly exemplified in Table 2. In other words, each of the selected wavelengths (which may be two or more) may be selected: (i) by knowing the powder material composition, powder particle size and shape and layer, based on the considerations disclosed herein, (ii) determining one or more of composition optical absorption, optical refraction, optical transmission, thermal conductivity, surrounding temperature and composition melting temperature, each of which may be independent or differently determined; (iii) based on the data choosing the two or more absorption depths; (iv) determining a spectral transmission of the powder bed composition, and, (v) based also on the spectral transmission determining the two different wavelengths that exhibit the optimal absorption depths. Such optimal depths may be same or similar or represented by one or more of the adsorption depths listed in Table 2. Others may also be considered and may be used.

TABLE 2

| First Wavelength | Second Wavelength |
|---|---|
| (adsorption depth, μm) | (adsorption depth, μm) |
| 0-10 | 0-50 |
| 0-15 | 0-75 |
| 0-10 | 0-50 |
| 0-25 | 0-75 |
| 0-50 | 0-150 |
| 0-10 | 0-150 |
| 0-20 | 0-175 |

The wavelength difference between the two wavelengths may be at least 0.5 μm when combining two wavelengths in the 3.7-15-micron range, using a dichroic mirror. It should be further noted that due to heat conduction and heat dissipation, the actual depths cannot be accurately measured. The values provided in Table 2 are approximates and define certain measurable properties of layers having a thickness of between 10 and 300 μm.

As demonstrated by the values in both Tables 1 and 2, the process comprises irradiating a powder bed formed of a material composition of the object by laser source being a single beam laser of two or more wavelengths or by two or more independent laser sources, each laser source generating a laser beam of a different characteristic, e.g., different wavelengths which are different by at least 0.5 μm, to thereby cause sintering or melting of the material composition at two different depths of the powder bed, wherein the depths may be as exemplified in Table 2.

The protocols disclosed herein may be implemented in a variety of processes of the invention carried out on a variety of powder compositions, for example:
1. a powder layer formed of a single material, wherein the layer is irradiated as disclosed to cause simultaneous or sequential sintering or melting at two different depth regions of the layer, wherein one of said layer depths being optionally a surface of the powder layer;
2. a powder layer formed of a combination of two or more different materials, homogeneously distributed in said layer, wherein the layer is irradiated as disclosed to cause simultaneous or sequential sintering or melting of the two or more different materials;
3. a powder layer having spaced apart material regions, each region being formed of a different material, wherein the spaced apart regions are simultaneously or sequentially irradiated as disclosed to cause simultaneous or sequential sintering or melting of the different materials in each of the spaced apart regions;
4. a powder multilayer formed of a plurality of stacked different material layers, wherein the multilayer is irradiated as disclosed to cause simultaneous or sequential sintering or melting of a topmost material layer as well as at least one material layer positioned under the topmost layer;
5. a powder multilayer formed of a plurality of stacked different material layers, wherein at least one of the material layers is a mixed material layer comprising a mixture of two or more materials, the multilayer is irradiated as disclosed to cause simultaneous or sequential sintering or melting of each of the two or more materials in the mixed material layer.

As stated herein, processes of the invention are based on a layer-by-layer deposition of powder particles. The polymer powder is spread layer-by-layer by a spreading means such as a blade or a roller that deposits a predetermined amount of powder of a given composition of one or more materials. The powder bed may be preheated and may be continuously heated during laser radiation. A laser beam that is (i) a single beam of two or more wavelengths or (ii) two or more laser beams that differ in at last one characteristic, e.g., wavelength, absorption depth, laser profile, polarizability and/or energy, is applied to melt the powder in a locally restricted area and/or depth of the layer according to a digitally programmed design. The laser placed at a region above a building platform holding the powder bed selectively melts powder particles of different compositions present in the powder mixture on the surface of the powder bed and/or powder particles of the same or different composition at inner regions of the layer, depending on the particular lasers used (having different wavelengths). The melting pattern typically follows a computer-controlled design.

Without wishing to be bound by theory, the laser interacts with the powder components based on the laser wavelength and the absorption behavior of the powder or a component thereof and is absorbed by it. The melted powder particles sinter or coalesce at temperatures higher than the powder melting point and solidify upon cooling to the bed temperature. The absorption characteristics of the powder or component thereof at a given wavelength adopted and the ability of the laser to impact the powder layer at deeper regions, determined as disclosed herein allow for a successful sintering process. These have a direct effect on the heat energy generated from the laser irradiation and thus the penetration depth of the laser beam, and the dimensions of the melted regions (along the horizontal and vertical axis defining the powder layer).

As a powder layer is sintered or solidified, a new layer of powder is spread or deposited and the processes is repeated until the desired object is formed.

As arises from the disclosure herein, the term “sinter” refers to a process of coalescing or bonding particles or grains of the powder material into a solid continuous material forming the object to be formed. The coalescing is achieved by heating the particles or grains to a temperature that nearly liquefies the particles or grains. The sintering temperature may be selected such that crystal structure of the particles or grains remain following coalescence or changes into an amorphous form.

Due to the ability of processes of the invention to permit simultaneous sintering of two or more powder materials and/or simultaneous sintering of powder particles at two or more different depths of the powder layer, customized and intricate objects with superior mechanical properties may be fabricated. Objects and workpieces that may be manufactured include connectors, hinges, housings, electronic housings, complex assemblies, enclosures, prosthetics, footwear, sealings, grippers, pipes, car interior components, damping elements, bumpers, bellows, soles, handles, hoses, sports equipment, automobile components, engine parts, mounts and brackets, replace metal parts, aerospace components, electrical components, automotive motors, jigs, fixtures, and manufacturing aids for the electronics industry and others.

Objects and workpieces that may be manufactured include connectors, hinges, housings, electronic housings, complex assemblies, enclosures, prosthetics, footwear, sealings, grippers, pipes, car interior components, damping elements, bumpers, bellows, soles, handles, hoses, sports equipment, automobile components, engine parts, mounts and brackets, replace metal parts, aerospace components, electrical components, automotive motors, jigs, fixtures, and manufacturing aids for the electronics industry and others.

The invention further provides a system for forming a 3D object or a workpiece by selective laser sintering, the system comprising at least one laser source configured and operable for emitting a combined laser beam comprising two or more lasers of different wavelengths, and a building platform configured for receiving a layer of a powder material composition of the object, said platform being positioned in a pathway of the combined laser beam, and wherein one or both of the laser beam and platform is movable to sinter or melt said material composition in at least two predetermined regions or depths of the layer.

In some embodiments, the combined beam is generated by combining two beams generated by a single laser source. In some embodiments, the combined beam is generated by combining two beams generated by different laser sources.

In some embodiments, the system comprises a multi-wavelength combiner for combining multiple wavelength laser beams into the combined laser beam.

In some embodiments, the combiner may be a diffraction grating or a dichroic mirror.

In some embodiments, the system may comprise a polarizing beam splitter (PBS).

In some embodiments, the at least one laser source is an energy or light source configured to emit radiation coherently.

In some embodiments, the laser source may comprise a single gain medium, e.g., a single semiconductor component operable for emitting coherent radiation (typically at a single central or mean wavelength).

In some embodiments, the laser source having an emission spectrum characterized by an emission range within less than 15% of a mean emission wavelength.

In some embodiments, the laser source may be a tunable laser source having at least one controllable or adjustable property.

Also provided is a system for forming a 3D object or a workpiece, the system comprising
a surface configured for receiving a layer of a powder material for forming said object;
a feeding means for supplying said powder material in successive layers onto said surface;
a leveling means for leveling each of said successive layers of the powder material on said surface before laser irradiation; and
at least one laser source configured and operable for emitting a combined laser beam comprising two or more lasers of different wavelengths,
wherein the laser source is positioned to irradiate each of said successive layers of the powder material based on a predesign to cause simultaneous or sequential sintering of two or more materials of the powder materials and/or two or more regions at different depths of the successive layers.

Thus, the invention provides:

A process for forming an object or a workpiece, the process comprising irradiating a powder bed formed of a material composition of the object (i) by a single laser beam generated by a laser source, wherein said single laser beam being of two or more wavelengths, or (ii) by two or more laser beams, each having a different wavelength and each generated by a different laser source, to thereby cause sintering or melting of the material composition at two different depths of the powder bed.

A process for forming an object or a workpiece, the process comprising irradiating a powder bed formed of a material composition of the object (i) by a single laser beam generated by a laser source, wherein said single laser beam being of two or more wavelengths, or (ii) by two or more laser beams combined into a single beam, each of the two or more laser beams having a different wavelength and each generated by a different laser source, wherein the irradiation of the powder bed causes sintering or melting of the material composition at two different depths of the powder bed.

In some configurations of the process, the process comprising deposition of successive layers of the material composition, wherein each layer is irradiated and sintered prior to deposition of a further material layer.

In some configurations of the process, the sintering causes particles of the material composition to coalesce laterally and into predetermined depths of the powder bed.

In some configurations of the process, the irradiating comprises directing a single beam laser of two or more wavelengths in a direction of a region of the powder bed to thereby cause sintering of the powder bed at two different depths thereof.

In some configurations of the process, the irradiating comprises directing two or more laser beams, each generated from an independent laser source and each being of a different wavelength in a direction of a region of the powder bed, to thereby cause sintering of the powder bed at two different depths thereof.

In some configurations of the process, the process comprising layer-by-layer sintering of a material composition of the object, wherein a powder layer having a predetermined material composition and thickness is irradiated by a single beam laser of two or more wavelengths or by two or more different simultaneously generated laser beams, each having a different wavelength, causing sintering or melting of the material composition at two different depths of the layer.

In some configurations of the process, a first wavelength is selective to cause sintering or melting of the material composition at a first depth of the powder bed, and a second wavelength is selective to cause sintering of the material composition at a second depth of the powder bed, wherein a laser of the first wavelength and a laser of the second wavelength are generated simultaneously and wherein the first and second depths of the powder layer are separated by a distance of at least 10 microns.

In some configurations of the process, the single laser beam is formed by a multi-wavelength combiner.

In some configurations of the process, the process comprising combining two or more laser beams of different wavelengths into a single combined laser beam using a diffraction grating or a dichroic mirror.

In some configurations of the process, any of the laser beams is selected from a quantum cascade laser (QCL), or a CO₂ laser.

In some configurations of the process, the different wavelengths differ by at least 0.1 or at least 0.5 μm.

In some configurations of the process, the material composition comprises a single or a plurality of materials.

In some configurations of the process, the material composition is thermoplastic.

In some configurations of the process, the material composition comprises or consists polyamide polymers, polypropylene, polybutylene terephthalate (PBT), poly ether ether ketone (PEEK), poly ether ketone ketone (PEKK), thermoplastic amide (TPA), thermoplastic copolyester (TPC), and/or thermoplastic polyurethane (TPU).

In some configurations of the process, the material further comprising a functional additive.

In some configurations of the process, the functional additive is carbon fibers, glass beads; fire retardant materials; or colorants.

In some configurations of the process, the material composition comprises or consists Nylon 6, Nylon 11, Nylon 12, polyamide with carbon fibers, polyamide with electrostatic discharging capabilities, polyamide with a flame retardant, polyamide with glass fibers or glass beads, PBT, PEEK, PEKK, polypropylene, TPA, TPC, and/or TPU.

In some configurations of the process, the material composition is provided in a particulate form.

In some configurations of the process, the powder bed or the layer thickness is between about 10 and 300 μm or between 10 and 150 μm.

In some configurations of the process, the different wavelengths suitable for sintering the powder bed at two different depths are determined by (i) determining powder material composition, powder particle size and shape and layer, (ii) determining one or more of composition optical absorption, optical refraction, optical transmission, thermal conductivity, surrounding temperature and composition melting temperature, (iii) selecting at least two absorption depths; (iv) determining a spectral transmission of the composition, and, (v) determining the two different wavelengths that exhibit the optimal absorption depths.

In some configurations of the process, the process is carried out on a system comprising at least one laser source configured and operable for emitting a combined laser beam comprising two or more lasers of different wavelengths, and a building platform configured for receiving a layer of a powder material composition of the object, said platform being positioned in a pathway of the combined laser beam, and wherein one or both of the laser beam and platform is movable to sinter or melt said material composition in at least two predetermined depths of the layer.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1: Dichroic mirror transmitting a combined laser beam generated from two laser sources and each having a different wavelength.

FIG. 2: A system according to some embodiments of the invention demonstrating the combining of two laser beams, each with different polarizations and wavelengths.

FIG. 3: Simultaneously melting a layer of a material composition utilizing two lasers at two different wavelengths and absorption depths. resulting in higher print speed and better printed part mechanical properties.

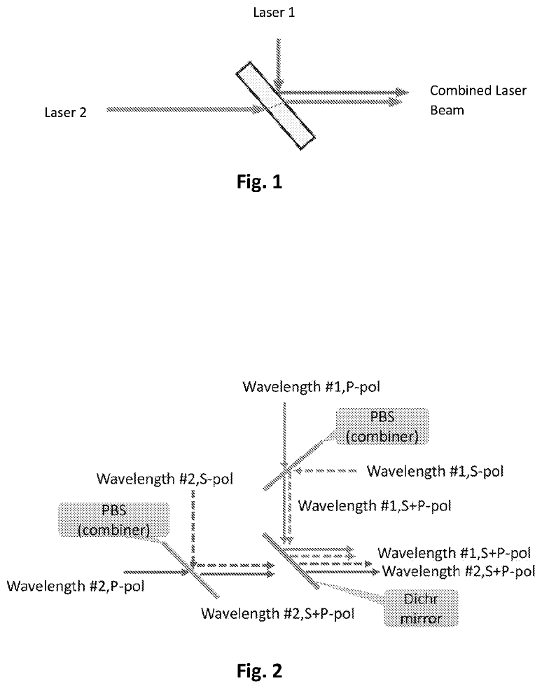

### DETAILED DESCRIPTION OF EMBODIMENTS

Objects formed according to the invention have been prepared as demonstrated herein. While the conditions indicated are specific, these conditions are not limiting in any way and may vary based on the printing system used.

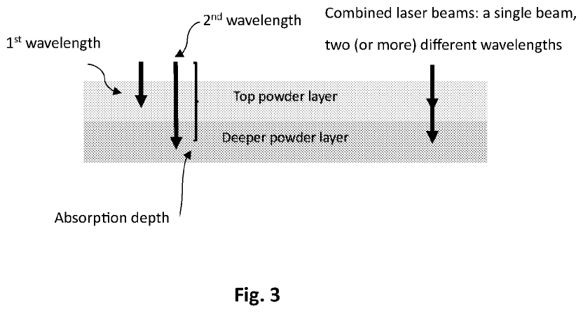

As demonstrated in the figures, and specifically in FIG. 3, a two-wavelength single laser beam may be used to irradiate a material composition arranged in as a powder bed or a layer. The two laser types with two different wavelengths and absorption depths are irradiated to cause sintering of the material in the layer. Subsequent deposition of further layers and sintering each of the layers, following an SLS deposition protocol results in a better melting of the material in the layer and inter-layer adhesion of the pattern.

In an Example, the material Pat2 was used to form an object. The plate and piston temperature were 80 °C. A 100-micron layer was first deposited and recoating was achieved with the use of a roller. Layer pre-heating was to a temperature of 174 °C using one or a plurality of IR lamps.

Dual wavelength beam head was used to generate 4 lasers, defining two different wavelengths, were combined into a single combined beam using a polarizing beam splitter and a dichroic mirror). The combined beam was used to selectively melt the material using a 2D mirror scanner and a dynamic focus module.

The process was repeated until all layers were printed.

The object was subsequently cooled down over a period of 12 hours.

1.-21. (canceled)

22. A process for forming an object or a workpiece, the process comprising irradiating a powder bed formed of a material composition of the object (i) by a single laser beam generated by a laser source, wherein said single laser beam being of two or more wavelengths, or (ii) by two or more laser beams combined into a single beam, each of the two or more laser beams having a different wavelength and each generated by a different laser source, wherein the irradiation of the powder bed causes sintering or melting of the material composition at two different depths of the powder bed.

23. The process according to claim 22, comprising deposition of successive layers of the material composition, wherein each layer is irradiated and sintered prior to deposition of a further material layer.

24. The process according to claim 22, wherein sintering causes particles of the material composition to coalesce laterally and into predetermined depths of the powder bed.

25. The process according to claim 22, wherein the irradiating comprises directing a single beam laser of two or more wavelengths in a direction of a region of the powder bed to thereby cause sintering of the powder bed at two different depths thereof.

26. The process according to claim 22, wherein the irradiating comprises directing two or more laser beams, each generated from an independent laser source and each being of a different wavelength in a direction of a region of the powder bed, to thereby cause sintering of the powder bed at two different depths thereof.

27. The process according to claim 22, comprising layer-by-layer sintering of a material composition of the object, wherein a powder layer having a predetermined material composition and thickness is irradiated by a single beam laser of two or more wavelengths or by two or more different simultaneously generated laser beams, each having a different wavelength, causing sintering or melting of the material composition at two different depths of the layer.

28. The process according to claim 27, wherein a first wavelength is selective to cause sintering or melting of the material composition at a first depth of the powder bed, and a second wavelength is selective to cause sintering of the material composition at a second depth of the powder bed, wherein a laser of the first wavelength and a laser of the second wavelength are generated simultaneously and wherein the first and second depths of the powder layer are separated by a distance of at least 10 microns.

29. The process according to claim 22, wherein the single laser beam is formed by a multi-wavelength combiner.

30. The process according to claim 22, comprising combining two laser beams of different wavelengths into a single combined laser beam using a diffraction grating or a dichroic mirror.

31. The process according to claim 22, wherein any of the laser beams is selected from a quantum cascade laser (QCL), or a CO₂ laser.

32. The process according to claim 22, wherein the different wavelengths differ by at least 0.1 or at least 0.5 μm.

33. The process according to claim 22, wherein the material composition comprises a single or a plurality of materials.

34. The process according to claim 33, wherein the material composition is thermoplastic.

35. The process according to claim 34, wherein the material composition comprises or consists polyamide polymers, polypropylene, polybutylene terephthalate (PBT), poly ether ether ketone (PEEK), poly ether ketone ketone (PEKK), thermoplastic amide (TPA), thermoplastic copolyester (TPC), and/or thermoplastic polyurethane (TPU).

36. The process according to claim 33, further comprising a functional additive.

37. The process according to claim 36, wherein the functional additive is carbon fibers, glass beads; fire retardant materials; or colorants.

38. The process according to claim 35, wherein the material composition comprises or consists Nylon 6, Nylon 11, Nylon 12, polyamide with carbon fibers, polyamide with electrostatic discharging capabilities, polyamide with a flame retardant, polyamide with glass fibers or glass beads, PBT, PEEK, PEKK, polypropylene, TPA, TPC, and/or TPU.

39. The process according to claim 22, wherein the material composition is provided in a particulate form.

40. The process according to claim 22, wherein the powder bed or the layer thickness is between about 10 and 300 μm or between 10 and 150 μm.

41. The process according to claim 22, wherein the different wavelengths suitable for sintering the powder bed at two different depths are determined by (i) determining powder material composition, powder particle size and shape and layer, (ii) determining one or more of composition optical absorption, optical refraction, optical transmission, thermal conductivity, surrounding temperature and composition melting temperature, (iii) selecting at least two absorption depths; (iv) determining a spectral transmission of the composition, and, (v) determining the two different wavelengths that exhibit the optimal absorption depths.

42. The process according to claim 22, carried out on a system comprising at least one laser source configured and operable for emitting a combined laser beam comprising two or more lasers of different wavelengths, and a building platform configured for receiving a layer of a powder material composition of the object, said platform being positioned in a pathway of the combined laser beam, and wherein one or both of the laser beam and platform is movable to sinter or melt said material composition in at least two predetermined depths of the layer.
